(19) United States
(12) Patent Application Publication
(10) Pub. No.: US 2007/0294527 A1
(43) Pub. Date: Dec. 20, 2007

(54) Reconfigurable portable digital device and a method to reconfigure a setup of a portable digital device

(75) Inventors: Yew Teng Too, Singapore (SG); Wong Hoo Sim, Singapore (SG)

Correspondence Address: CREATIVE LABS, INC.;LEGAL DEPARTMENT, 1901 MCCARTHY BLVD, MILPITAS, CA, 95035, US

(73) Assignee: Creative Technology Ltd

(21) Appl. No.: 11/454,970

(22) Filed: Jun. 15, 2006

(51) Int. Cl. H04L 9/00

(52) U.S. Cl. 713/159

(57) ABSTRACT

There is provided a portable digital device including: a display; a processor for rotating content shown on the display from a first orientation to a second orientation; a connector for connection of the portable digital device to a peripheral device; and at least two control devices for controlling at least two operational functions of the portable digital device. It is advantageous that the content shown on the display is automatically rotated from a first orientation to a second orientation by the processor when a functional connection to the peripheral device is made using the connector. The content may be rotated as a single entity or it may be rotated pixel-by-pixel. Depending on the peripheral device, the rotation may be either 90° or 180°. The functional connection may preferably be detected by the processor using a mechanical switch, an impedence meter and a combination of the aforementioned. There is also provided a method for automatically reconfiguring a setup of a portable digital device.

### FIELD OF INVENTION

The present invention relates to a portable digital device that is reconfigurable in terms of setup such as displays and/or controls. A method to reconfigure a setup of the portable digital is also disclosed.

### BACKGROUND

The increasing uptake of portable digital devices has led to a corresponding increase in the numbers and variety of accessory peripheral devices available on the market. Many of the accessory peripheral devices are specifically designed for specific models of portable digital devices and are incompatible with other models of portable digital devices.

Different portable digital devices may have connectors to accessory peripheral devices located at various positions of the device. For example, some of the portable digital devices may have a earphone/headphone socket located at a top edge of the portable digital devices while some of the portable digital devices may have earphone/headphone sockets located at a base. The location of such connectors may also be dependent on the form factor of the portable digital device and how the portable digital device is designed to be used. Some portable digital devices like Creative Technology Ltd's Zen Vision is designed to be held along its length when in use while other portable digital devices like a Zen Vision M also from Creative Technology Ltd is designed to be held along its width when in use.

While it may be possible to functionally connect any device with a earphone jack to the portable digital devices regardless of the location of the socket, a connection between the socket and the jack may cause the content on the display to be inverted or tilted sideways. Thus, the display with content on the portable digital device may not be easily and conveniently viewable, which is highly undesirable when many portable digital devices are able to be used for viewing photos and/or movies.

### SUMMARY

There is provided a portable digital device including: a display; a processor for rotating content shown on the display from a first orientation to a second orientation; a connector for connection of the portable digital device to a peripheral device; and at least two control devices for controlling at least two operational functions of the portable digital device. It is advantageous that the content shown on the display is automatically rotated from a first orientation to a second orientation by the processor when a functional connection to the peripheral device is made using the connector. The content may be rotated as a single entity or it may be rotated pixel-by-pixel. Depending on the peripheral device, the rotation may be either 90° or 180°. The functional connection may preferably be detected by the processor using a mechanical switch, an impedence meter and a combination of the aforementioned.

It is preferable that the at least two operational functions are selected from the group comprising: skip forwards, skip backwards, increase volume, decrease volume, selector on display move left, selector on display move right, selector on display move up, and selector on display move down. The at least two operating functions of the at least two control devices may be automatically interchanged when an extent of rotation of content shown on the display is greater than 100°. The connector may preferably be a female receptor of the type such as, for example, a earphone jack, a USB connector, an IEEE1394 connector, and a proprietary connector. Preferably, the peripheral device may be a set of earphones, a set of headphones, a set of speakers, or a wireless transceiver.

The portable device may be a media player, a mobile telephone, or a portable digital assistant (PDA).

There is also provided a method for automatically reconfiguring a setup of a portable digital device. The method includes connecting the portable digital device to a peripheral device; a processor in the portable digital device detecting the connection of the portable digital device to the peripheral device; and rotating the content shown in the display of the portable digital device from a first orientation to a second orientation. The method may further include interchanging at least two operational functions of at least two control devices of the portable digital device when an extent of rotation of content shown on the display is greater than 100°.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a block diagram of a preferred embodiment of the present invention.

FIG. 2 shows a perspective view of a possible embodiment of the present invention.

FIG. 3 shows a top view of the possible embodiment of the present invention.

FIG. 4 shows a perspective view of a peripheral device connectable to the possible embodiment of the present invention.

FIG. 5 shows a front view of the peripheral device of FIG. 4 when connected with the possible embodiment of the present invention.

FIG. 6 shows a flow chart of a preferred method of the present invention.

### DESCRIPTION OF PREFERRED EMBODIMENTS

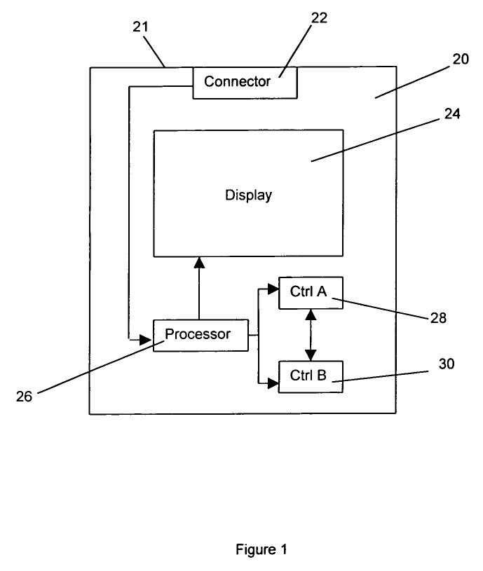

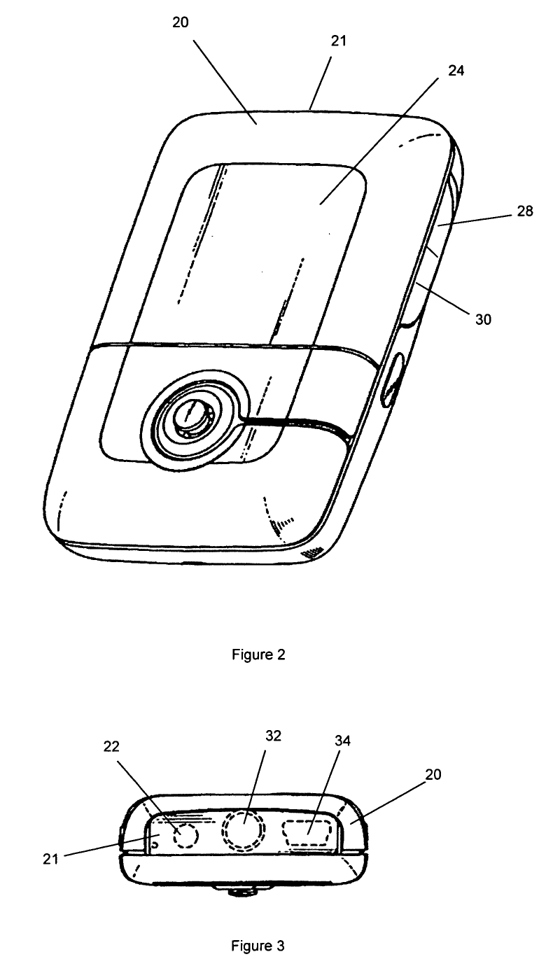

Referring to FIG. 1, there is shown a block diagram of a portable digital device 20. The portable digital device 20 may be a media player, a mobile telephone, or a portable digital assistant (PDA). The portable digital device 20 may include a display 24 to show content stored in or accessible by the portable digital device 20. The display 24 may be an LCD, TFT or OLED panel. The display 24 may be colour or monochrome. The display 24 is also shown in a possible embodiment in FIG. 2.

The portable digital device 20 may also include a processor 26. The processor 26 may include several routines and algorithms that enable the rotation of content shown on the display 24 from a first orientation to a second orientation when certain conditions (that will be described later) are met. The content may be rotated as a single entity or it may be rotated pixel-by-pixel. The processor 26 may also control some or all other processes performed by the portable digital device 20.

There may also be a connector 22 for connection of the portable digital device 20 to an external peripheral device. The location of the connector 22 may be dependent on the form factor of the portable digital device 20 and how the portable digital device 20 is designed to be used. The connector 22 may be a female receptor such as, for example, a earphone jack, a USB connector, an IEEE1394 connector, or a proprietary connector. In this preferred embodiment, the connector 22 is located at a top edge 21 of the portable digital device 20. In this instance, the connector 22 is located at such a position as a peripheral device like a set of earphones or headphones may be easily connected when the portable digital device 20 is in operation in an orientation as shown in the possible embodiment in FIG. 2, which shows the preferred orientation of the portable digital device 20 when in use. In a top view of a possible embodiment of the portable digital device 20 as shown in FIG. 3, the connector 22 is a earphone jack socket. Other peripheral devices that may be connected may include either a set of speakers, or a wireless transceiver. It can be seen from FIG. 3 that there may be other connectors 32, 34 on the top edge 21 of the portable digital device 20.

There may also be at least two controls, control A 28, control B 30 for operating at least two operational functions of the portable digital device 20. The at least two operational functions may be for example, skip forwards, skip backwards, increase volume, decrease volume, selector on display move left, selector on display move right, selector on display move up, and selector on display move down. Control A 28 and control B 30 are also shown in the possible embodiment of FIG. 2.

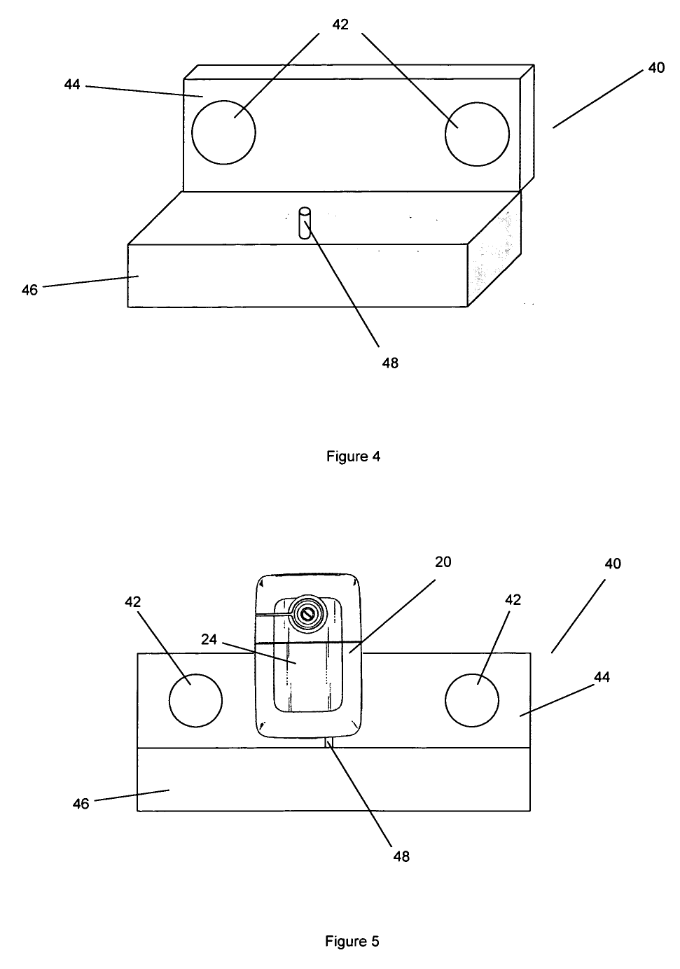

Referring to FIG. 4, there is shown a perspective view of a peripheral device 40 that is connectable to the portable digital device 20. The peripheral device 40 of FIG. 4 is a simplified representation of Traveldock 900 speakers made by Creative Technology Ltd. The peripheral device 40 includes a first panel 44 and a second panel 46. The first panel 44 includes speaker drivers 42, enclosures, and related componentry. The second panel 46 includes a male connector 48 (earphone jack) and may also include related circuitry and componentry to enable the peripheral device 40 to function in a prescribed manner. No special modification has been made to the peripheral device 40 when compared to those obtainable from the public domain.

FIG. 5 shows a front view of the possible embodiment of the portable digital device 20 being functionally connected to the peripheral device 40 via the male connector 48. Referring to FIG. 2, it is evident that the portable digital device 20 is not positioned in its preferred orientation of use when connected to the peripheral device 40. It can be seen that the portable digital device 20 is positioned in an upside down manner. However, when such an instance shown in FIG. 5 occurs, content shown on the display 24 may be automatically rotated from a first orientation (the preferred orientation of use) to a second orientation by the processor 26. The content may be rotated as a single entity or it may be rotated pixel-by-pixel. The rotation of the content shown on the display 24 allows for convenient viewing of the content by a user when the portable digital device 20 is connected to the peripheral device 40. In this instance, the rotation of the content is by 180°. The extent of rotation of the content may also be by 90°, where the actual extent of rotation may depend on the preferred orientation of use of the portable digital device 20. The extent of rotation may be pre-programmed into the processor 26 and may be matched to a particular peripheral device as different peripheral devices may have connectors located at different places/orientations. The processor 26 in the portable digital device 20 may detect the functional connection to the peripheral device 40 by the use of a mechanical switch, an impedence meter or a combination of the aforementioned.

In addition, besides the rotation of the content in the display 24 of the portable digital device 20, the at least two operational functions of the at least two controls, control A 28, control B 30 may also be automatically reversed when the portable digital device 20 is functionally connected to the peripheral device 40 and when the extent of rotation of the content in the display 24 is greater than 100°.

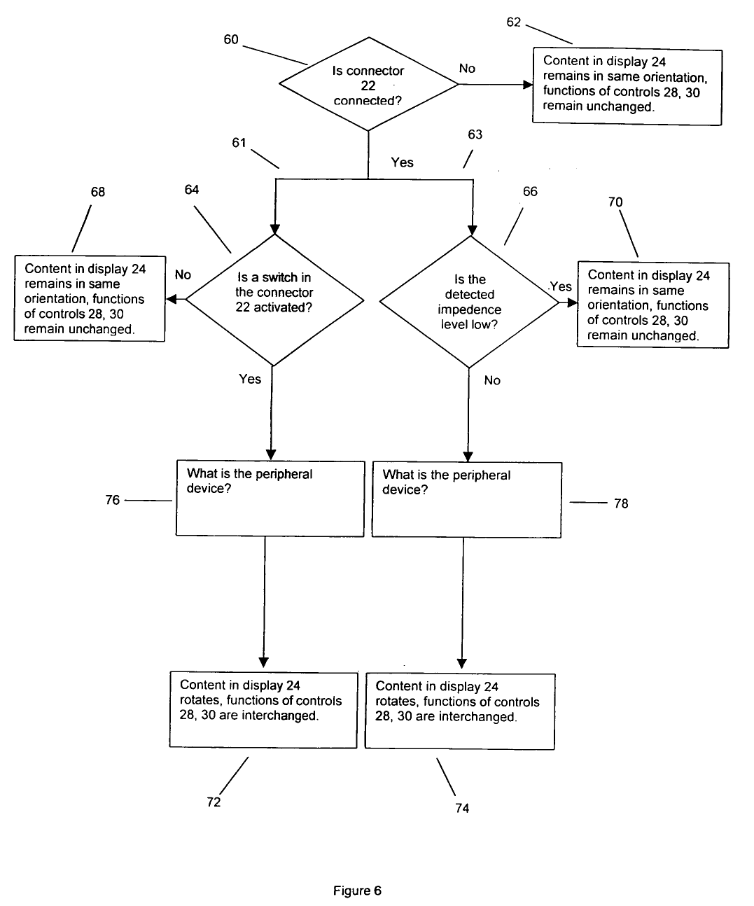

FIG. 6 shows a preferred method of how the processor 26 of the portable digital device 20 determines that a peripheral device 40 has been functionally connected and subsequently determines the extent of rotation of the content on the display 24 of the portable digital device 20. Firstly, the processor 26 determines whether the portable digital device 20 is functionally connected to a peripheral device through the connector 22 (60). The processor 26 may rely on a mechanical switch, an impedence meter or a combination of the aforementioned to detect the functional connection of the portable digital device 20 to the peripheral device. If no functional connection is detected, then content in display 24 remains in the same orientation and the operational functions of controls 28, 30 remain unchanged (62). However, if a functional connection is detected by the processor 26, then either of paths 61 or 63 may be utilised, depending on how the functional connection is set up to be detected.

If a mechanical switch is solely used to detect the functional connection, path 61 is adopted in the method. The processor 26 determines whether a switch in the connector 22 is activated (64). If the switch in the connector 22 is not activated, then content in display 24 remains in the same orientation and the functions of controls 28, 30 remain unchanged (68) as a headphone/earphone set would not trigger the switch in the connector 22 even though they are also peripheral devices. If the switch in the connector 22 is activated because of a connection to a peripheral device with a connector that activates the switch in the connector 22 (like the speakers shown in FIG. 4), the processor 26 then determines the type of peripheral device connected to the portable digital device 20. This detection may be done as the activation of the switch in the connector 22 may only be done by a certain group of peripheral devices, such as, for example, speakers from a particular brand. Subsequent to the processor 26 ascertaining the type of peripheral device (76), the processor 26 then determines the extent of rotation for the content in the display 24 from a first orientation (the preferred orientation of use) to a second orientation. The content may be rotated as a single entity or it may be rotated pixel-by-pixel. The operational functions of controls 28, 30 are interchanged only if the extent of rotation of the content in the display 24 is greater than 100°(72).

If an impedence meter is solely used to detect the functional connection, path 63 is adopted in the method instead. The processor 26 determines the impedence level of the connected peripheral device (66). If the impedence level of the connected peripheral device is relatively low, then content in display 24 remains in the same orientation and the functions of controls 28, 30 remain unchanged (70) as a headphone/earphone set has relatively low impedences. If the impedence level of the connected peripheral device is relatively high (like the speakers shown in FIG. 4), the processor 26 then determines the type of peripheral device connected to the portable digital device 20. This may be done by associating ranges of impedence levels with particular types of peripheral devices. Subsequent to the processor 26 ascertaining the type of peripheral device (78), the processor 26 then determines the extent of rotation for the content in the display 24 from a first orientation (the preferred orientation of use) to a second orientation. The content may be rotated as a single entity or it may be rotated pixel-by-pixel. The functions of controls 28, 30 are interchanged only if the extent of rotation of the content in the display 24 is greater than 100° (74).

The mechanical switch may also be used in combination with the impedence meter to detect the functional connection. The combination may be employed with the mechanical switch as a first check (box 64 in FIG. 6) prior to using the impedence meter for determining the type of peripheral device connected to the portable digital device 20. The converse may also be possible, where the impedence meter is used as the first check (box 66 in FIG. 6) prior to using the mechanical switch for determining the type of peripheral device connected to the portable digital device 20.

Whilst there has been described in the foregoing description preferred embodiments of the present invention, it will be understood by those skilled in the technology concerned that many variations or modifications in details of design or construction may be made without departing from the present invention.

1. A portable digital device including:
a display;
a processor for rotating content shown on the display from a first orientation to a second orientation; a connector for connection of the portable digital device to a peripheral device; and
at least two control devices for controlling at least two operational functions of the portable digital device;
wherein the content shown on the display is automatically rotated from a first orientation to a second orientation by the processor when a functional connection to the peripheral device is made using the connector.

2. The portable device as claimed in claim 1, wherein the at least two operational functions are selected from the group comprising: skip forwards, skip backwards, increase volume, decrease volume, selector on display move left, selector on display move right, selector on display move up, and selector on display move down.

3. The portable device as claimed in claim 1, wherein the connector is a female receptor of the type selected from the group comprising: a earphone jack, a USB connector, an IEEE1394 connector, and a proprietary connector.

4. The portable device as claimed in claim 1, wherein the peripheral device is selected from the group comprising: a set of earphones, a set of headphones, a set of speakers, and a wireless transceiver.

5. The portable device as claimed in claim 1, wherein the rotation is selected from the group comprising: 90° and 180°.

6. The portable device as claimed in claim 1, wherein the rotation depends on the peripheral device.

7. The portable device as claimed in claim 1, wherein the functional connection is detected by the processor using means selected from the group selected from: a mechanical switch, an impedence meter and a combination of the aforementioned.

8. The portable device as claimed in claim 1 is selected from the group comprising: a media player, a mobile telephone, and a portable digital assistant (PDA).

9. The portable device as claimed in claim 1, wherein the at least two operating functions of the at least two control devices are automatically interchanged when an extent of rotation of content shown on the display is greater than 100°.

10. The portable device as claimed in claim 1, wherein the content shown on the display is rotated from a first orientation to a second orientation as either a single entity or pixel-by-pixel.

11. A method for automatically reconfiguring a setup of a portable digital device, including:
connecting the portable digital device to a peripheral device;
a processor in the portable digital device detecting the connection of the portable digital device to the peripheral device; and rotating the content shown in the display of the portable digital device from a first orientation to a second orientation.

12. The method as claimed in claim 11, further including interchanging at least two operational functions of at least two control devices of the portable digital device when an extent of rotation of content shown on the display is greater than 100°.

13. The method as claimed in claim 11, wherein the at least two operational functions are selected from the group comprising: skip forwards, skip backwards, increase volume, decrease volume, selector on display move left, selector on display move right, selector on display move up, and selector on display move down.

14. The method as claimed in claim 11, wherein the portable digital device is connected to the peripheral device using matching connectors of the type selected from the group comprising: a earphone jack, a USB connector, an IEEE1394 connector, and a proprietary connector.

15. The method as claimed in claim 11, wherein the peripheral device is selected from the group comprising: a set of earphones, a set of headphones, a set of speakers, and a wireless transceiver.

16. The method as claimed in claim 11, wherein the rotation is selected from the group comprising: 90° and 180°.

17. The method as claimed in claim 11, wherein the rotation depends on the peripheral device.

18. The method as claimed in claim 11, wherein the connection of the portable digital device to the peripheral device is detected by the processor using means selected from the group selected from: a mechanical switch, an impedence meter and a combination of the aforementioned.

19. The method as claimed in claim 11, wherein the portable digital device is selected from the group comprising: a media player, a mobile telephone, and a portable digital assistant (PDA).

20. The method as claimed in claim 11, wherein the content shown on the display is rotated from a first orientation to a second orientation as either a single entity or pixel-by-pixel.
